(19) United States
(12) Patent Application Publication
(10) Pub. No.: US 2016/0224897 A1
(43) Pub. Date: Aug. 4, 2016

(54) Information Processing Method and Information Processing Device

(71) Applicant: Lenovo (Beijing) Co., Ltd, Beijing (CN)

(72) Inventor: Jin Wang, Beijing (CN)

(73) Assignee: LENOVO (BEIJING) CO., LTD., Beijing (CN)

(21) Appl. No.: 14/755,910

(22) Filed: Jun. 30, 2015

(30) Foreign Application Priority Data
Jan. 30, 2015 (CN) 201510051629.3

(51) Int. Cl. G06N 5/04

(52) U.S. Cl. CPC G06N 5/04

(57) ABSTRACT

An information processing method and a device are described. The method is applied to an electronic apparatus and includes acquiring user behavior data, wherein the user behavior data indicates a historical operation behavior of the user with respect to a first article; and predicting time of a future operation behavior of the user with respect to a second article according to at least the user behavior data, wherein the second article is an article same as or different from the first article in category, and the future operation behavior is an operation behavior same as or different from the historical operation behavior in category. Therefore, the information processing method provided by the present disclosure enables that information content interested by the user can be timely and accurately recommended to the user.

This application claims priority to Chinese Patent Application No. 201510051629.3 filed on Jan. 30, 2015; the entire contents of which are incorporated herein by reference.

The present disclosure relates to a technical field of computer, and more particularly, to an information processing method and an information processing device.

### BACKGROUND

With rapid development of information technology and Internet technology, the amount of information that people are exposed to every day is increasing at a high speed, such that both information consumers and information producers face great challenges. For the information consumers, it is hard to find their interested content from large amount of information; while for the information producers, it is also very hard to highlight their information out of massive content to get attention of majority of users.

In order to solve this conflict, there is proposed an information recommendation method, which is used for associating targets of the information consumers with those of the information producers. On one hand, the information consumers can be helped to find information valuable to themselves, and on the other hand, the information producers can show related information to the users who are interested in the related information, thereby realizing a win-win situation for both the information producers and the information consumers.

Taking an application scenario of commodity recommendation as an example, most of typical information recommendation methods recommend candidate commodities to a user purely depending on a commodity browsing history of the user. Accordingly, even if the user has just finished purchasing certain type of commodity, a commodity supplier will still continue to push purchasing information about such type of commodity to the user. On the contrary, when the user needs to re-purchase such type of commodity after a period of time, the commodity supplier cannot learn about the purchasing demand of the user accurately to push an advertisement properly. Therefore, the user's demand cannot be met accurately.

### SUMMARY

According to one aspect of the present disclosure, there is provided an information processing method, which is applied to an electronic apparatus. The method comprises: acquiring user behavior data, wherein the user behavior data indicates a historical operation behavior of the user with respect to a first article; and predicting time of a future operation behavior of the user with respect to a second article according to at least the user behavior data, wherein the second article is an article same as or different from the first article in category, and the future operation behavior is an operation behavior same as or different from the historical operation behavior in category.

In addition, according to another aspect of the present disclosure, there is provided an information processing device, which is applied to an electronic apparatus. The device comprises: a behavior data acquiring unit, for acquiring user behavior data, wherein the user behavior data indicates a historical operation behavior of a user with respect to a first article; and an time predicting unit, for predicting time of a future operation behavior of the user with respect to a second article according to at least the user behavior data, wherein the second article is an article same as or different from the first article in category, and the future operation behavior is an operation behavior same as or different from the historical operation behavior in category.

The information processing method and device according to the embodiments of the present disclosure can be used for acquiring the historical operation behavior of the user with respect to the first article, and predicting the time of the future operation behavior of the user with respect to the second article according to at least the historical operation behavior of the user with respect to the first article, thus determining the right time for recommending content to the user. Therefore, the information processing method and device determine the right time for recommending content, such that the information content interested by the user can be timely and accurately recommended to the user.

Other features of the present disclosure will be elaborated in the subsequent specification, and will be partially obvious from the specification or known by implementing the present disclosure. The objective the present disclosure can be realized and acquired by structures specifically indicated in specification, claims and drawings.

### BRIEF DESCRIPTION OF THE DRAWINGS

The drawings are provided for a further understanding of the present disclosure, and constitute a part of the specification. The drawings together with the embodiments of the present disclosure are used to explain the present disclosure, rather than form a limitation to the present disclosure. In the drawings:

FIG. 1 shows an information processing method according to an embodiment of the present disclosure.

FIG. 2 shows an information device according to an embodiment of the present disclosure.

FIG. 3 shows an electronic apparatus according to an embodiment of the present disclosure.

### DETAILED DESCRIPTION

Respective embodiments of the present disclosure will be described in detail with reference to the drawings. Here, it should be noted that in the drawings, the same reference signs are given to constituting parts which basically have same or similar structures and functions, and repetitive description about them is omitted.

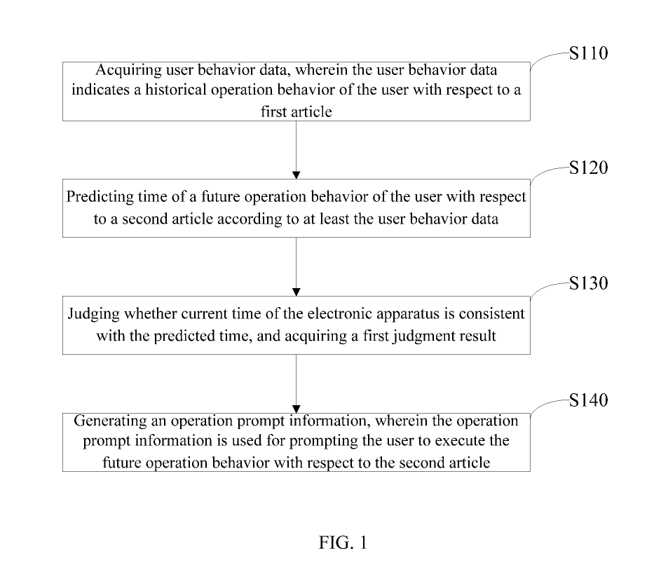

Firstly, an information processing method according to an embodiment of the present disclosure will be described with reference to FIG. 1.

FIG. 1 shows the information processing method according to the embodiment of the present disclosure.

The information processing method as shown in FIG. 1 is applied to an electronic apparatus. As shown in FIG. 1, the information processing method comprises steps of S110 to S140.

In step S110, acquiring user behavior data. The user behavior data indicates a historical operation behavior of the user with respect to a first article.

In step S102, predicting time of a future operation behavior of the user with respect to a second article according to at least the user behavior data. The second article is an article same as or different from the first article in category, and the future operation behavior is an operation behavior same as or different from the historical operation behavior in category.

In addition, as shown in FIG. 1, in one embodiment of the present disclosure, after the time of the future operation behavior of the user with respect to the second article is predicted according to at least the user behavior data (i.e., step S120), the information processing method may further comprises steps of S130 and S140.

In step S130, judging whether current time of the electronic apparatus is consistent with the predicted time, and acquiring a first judgment result.

In step S140, generating operation prompt information if the first judgment result indicates that the current time is consistent with the predicted time. The operation prompt information is used for prompting the user to execute the future operation behavior with respect to the second article.

Thus it can be seen, the information processing method according to the embodiment of the present disclosure can acquire the historical operation behavior of the user with respect to the first article, and predicting the time of the future operation behavior of the user with respect to the second article according to at least the historical operation behavior of the user with respect to the first article, so as to determine the right time for recommending the content to the user. Therefore, there is provided an information processing method, based on which the information content interested by the user can be timely and accurately recommended to the user. It should be noted that the historical operation behavior may refer to user's behavior, but not limited to the user's behavior, and the historical operation behavior may refer to article nature or features result in consumption of article. This is similar for the user behavior data.

In addition, the information processing method according to the embodiment of the present disclosure can also decide whether the operation prompt information is generated according to the current time, so as to prompt the user to execute the future operation behavior with respect to the second article at the right moment. Therefore information producers can push correct content to information consumers at right time.

In the embodiment of the present disclosure, the first article can be an article of any category. For example, the first article can be various commodities for sale purpose, or can be various non-commodities for non-sale purpose.

In a case that the first article is a commodity, the operation behavior with respect to the first article may include: acquiring behaviors (for example, purchasing behavior and receiving behavior), usage behavior, transferring behavior (for example, selling behavior and giving behavior), discarding behavior and the like or various combinations of the above two or more behaviors with respect to the commodity.

In a case that the first article is a non-commodity, the operation behavior with respect to the first article may include: acquiring behaviors (for example, producing behavior, picking behavior and receiving behavior), usage behavior, transferring behavior (for example, selling behavior and giving behavior), discarding behavior and the like or various combinations of the above two or more behaviors with respect to the article.

In addition, the second article can be a commodity or non-commodity same as the first article in category, or can be a commodity or non-commodity different from the first article in category but associated with the first article. For example, when the first article is a toothbrush, the second article may be toothbrush, or may be a toothpaste, a dental floss, a tooth-brushing cup or the like used together with the toothbrush.

Similarly, the future operation behavior with respect to the second article can be an operation behavior same as the historical operation behavior with respect to the first article in category, or the future operation behavior with respect to the second article can be an operation behavior different from the historical operation behavior with respect to the first article in category. For example, when the historical operation behavior with respect to the first article is that the user once purchased a toothbrush, the future operation behavior with respect to the second article can be that the user is about to purchase a toothbrush or that the user is about to purchase toothpaste, the user is about to replace the toothbrush, the user is about to clean a tooth-brushing cup or the like.

In addition, the time of the future operation behavior of the user with respect to the second article can at least depend on one or more historical operation behaviors of the user with respect to the first article.

For example, the time of the future purchasing behavior of the user with respect to the second article can only depend on a historical purchasing behavior of the user with respect to the first article, or can only depend on a historical usage behavior of the user with respect to the first article, or can depend on both the historical purchasing behavior and the historical usage behavior of the user with respect to the first article, or can further depend on other factors besides the historical operation behavior.

Hereinafter, the information processing method according to the embodiment of the present disclosure will be described in more detail in different embodiments.

In a first embodiment, it is assumed that the time of the future operation behavior of the user with respect to the second article only depends on a historical first operation behavior of the user with respect to the first article, and that the historical first operation behavior and the future operation behavior can be purchasing behaviors with respect to the first article and the second article. That is to say, the time of the future purchasing behavior of the user with respect to the second article can only depend on the historical purchasing behavior of the user with respect to the first article and is irrelevant of other historical behaviors (such as usage behavior) with respect to the first article.

A specific application scenario of the first embodiment can be that the user sets specific purchasing time for an article. Specifically, the article can be an article of which the purchasing behavior is closely related to time and has a time attribute. For example, a down jacket is only purchased and used in winter, flowers are usually purchased on specific holidays, and a seasonal food is often purchased and eaten in certain solar terms and the like.

In this case, the multiple historical purchasing behaviors of the user with respect to the first article can be analyzed to obtain a temporal rule of the multiple historical purchasing behaviors of the user with respect to the first article, so approximate time of the future purchasing behavior of the second article associated with the first article can be predicted according to the temporal rule.

Therefore, the step S110 may include: acquiring multiple historical first operation behavior data of the user with respect to the first article. For example, the first operation behavior can be a purchasing behavior.

Specifically, in step S110, the multiple purchasing behavior data (e.g., purchasing record) of the user with respect to the first article can be determined in various modes. For example, the purchasing behavior data can comprise multiple purchasing time of the user with respect to the first article. As mentioned above, as the purchasing behavior of the first article is only closely related to time and is irrelevant of other behaviors with respect to the first article, in the first embodiment, factors such as purchasing quantity and use speed of the user with respect to the first article may not be taken into consideration.

In one example, in a case that the user goes shopping on electronic shopping websites, registration accounts of the user on respective electronic shopping websites can be determined, and the user's shopping lists on the respective shopping websites can be searched by using the registration accounts, and information such as name, price, quantity and time of various articles purchased by the user can be recognized according to the shopping lists, so as to determine the time of the multiple purchasing of the user with respect to the first article.

In another example, in a case that the user goes shopping by using bankcards, bankcard accounts of the user on various bank websites can be determined, and transaction records of the user can be researched by using the bankcard accounts, and information such as name, price, quantity and time of various articles purchased by the user can be predicted according to the transaction records, so as to determine the time of the multiple purchasing of the user with respect to the first article.

In still another example, in a case that the user goes shopping with cash in a shopping mall, communication connection can be established with a data center (such as a cash register or a transaction server) of the shopping mall, to obtain a shopping receipt of the user at the shopping mall from the data center, and information such as name, price, quantity and time of various articles purchased by the user can be recognized according to the shopping receipt, so as to determine the multiple purchasing time of the user with respect to the first article.

In yet another example, an input device such as a camera or a microphone can be arranged in the electronic apparatus, the user can manually shoot the shopping receipt by using the camera and perform image recognition, or the user can artificially record purchasing information with respect to the first article by using the microphone and perform voice recognition, so as to determine the time of the multiple purchasing of the user with respect to the first article.

Next, after the multiple historical first operation behavior data of the user with respect to the first article are obtained (i.e., step S110) and before the time of the future operation behavior of the user with respect to the second article is predicted (i.e., step S120), the information processing method further comprises a step of: determining the second article according to the first article.

In one example, simply, the second article can be the first article per se. For example, the first article and the second article can be washing powder same in brand, product series and capacity.

In another example, the second article can be an article different from the first article but same as the first article in category, namely, the second article can be an article not completely same as the first article in aspects such as name, model or parameter. For example, the first article and the second article can be washing powder different in brand, product series and/or capacity.

In still another example, the second article can be an article which is different from the first article in category, namely, the second article can an article completely different from the first article in aspects such as name, model, and parameter. For example, the first article can be washing powder while the second article can be a collar cleaner, housework gloves or the like.

Specifically, the second article can be determined according to the first article by steps of: determining first category information of the first article; determining at least one candidate article according to the first category information; and determining one or more second articles from the at least one candidate article according to screening conditions.

For example, the above-mentioned operations can be completed by a content-based recommendation algorithm.

The content-based recommendation method has a theoretical basis mainly from information searching and information filtering, and the so-called content-based recommendation method is just to recommend items with which a user has no contact to the user according to a past browsing record of the user. Generally, the content-based recommendation method is described in two approaches: a heuristic approach and a model-based approach. The heuristic approach is that the user defines a related computational formula empirically, then verifies based on a calculating result of the formula and an actual result, and then constantly modifies the formula to achieve a final aim. The model-based approach is that past data are used as a dataset, and then a model is formed by studying the dataset. Generally, the heuristic approach applied in a common recommendation system is that keywords having higher weight of occurrence in a document are calculated by using a term frequency-inverse document frequency (tf-idf) method, and then these keywords are used as a vector to describe user features; then keywords having high weight of occurrence in a recommended item are used as attribute features of the recommended item and the item having the vector closest to the former vector (with highest point through calculating compared with the vector of user features) is recommended to the user. When similarity between the vector of the user features and the feature vector of the recommended item is calculated, a cosine method is used in general, namely, a cosine value of an included angle between the two vectors is calculated. As the principle of the content-based information recommendation method is well known by those skilled in the art, a detailed description thereof is omitted herein.

It should be noted that although the content-based recommendation algorithm is taken as an example for description, the present disclosure is not limited thereto. The above operation can also be implemented by using article recommendation algorithms such as a cooperative filtering-based recommendation method, a correlation rule-based recommendation method, an effect-based recommendation method, and a knowledge-based recommendation method and a combination of one or more of the above algorithms.

Furthermore, after the second article is determined, the step S120 may include: determining a historical first operation behavior mode according to the multiple historical first operation behavior data, wherein the historical first operation behavior mode indicates a temporal rule of the multiple historical first operation behaviors of the user with respect to the first article; and predicting the time of the future operation behavior of the user with respect to the second article according to current time and the historical first operation behavior mode.

Specifically, after the multiple purchasing behavior data of the user with respect to the first article are determined, in the step S120, the historical purchasing behavior mode of the user with respect to the first article may be firstly determined according to the multiple purchasing time of the user with respect to the first article, for example, the purchasing behavior mode indicates a temporal rule of the multiple historical purchasing behaviors of the user with respect to the first article.

In a first example, the temporal rule can be that a user purchases a certain product according to a certain purchasing period (for example, every other week, etc.). For example, the user may get used to purchase a finance product after get paid at the end of each month.

In a second example, the temporal rule can be that the user purchases a certain product at a non-fixed time interval which complies with certain rules (for example, related to various factors, such as seasons, holidays and mood). For example, due to allergies, the user may need to purchase a disposable mask for prevention during severe haze in winter and higher pollen concentration in spring, but needs not to purchase at other time.

Next, the current time can be acquired in modes such as reading a system clock of an electronic system, querying on internet or the like, and the time when the user will purchase the second article in the future can be determined according to the current time and the temporal rule of the multiple historical purchasing behaviors of the user with respect to the first article.

The case of purchasing the disposable mask is further taken as an example, when it is judged to be winter or spring according to the current time, the time when the user will purchase the disposable mask next time can be determined as next day; when it is judged to be summer or autumn according to the current time, the time when the user will purchase the disposable mask next time can be determined to the coming of winter.

After the time of the future operation behavior of the user with respect to the second article is determined, in the step S130, it can be judged whether the present time gets to or gets close to the time when the user will purchase the second article according to the current time of the electronic apparatus.

For example, it can be determined whether a time difference between the current time of the electronic apparatus and the predicted time is smaller than or equal to a preset threshold value. If yes, it is considered that the present time has gotten to or gotten close to the predicted time, and the information processing method proceeds to step S140. Otherwise, it is considered that the present time does not get to or get close to the predicted time, and the information processing method further executes the current judging operation till the current time of the electronic apparatus gets to or gets close to the predicted time.

If the current time has gotten to or gotten close to the time when the user will purchase the second article, in step S140, a purchase prompt information can be generated for prompting the user to purchase the second article at the predicted time.

For example, the purchase prompt information can be simple prompt information and can prompt the user that the second article needs to be purchased currently in modes such as screen displaying, sound playing and vibration triggering.

Alternatively, the purchase prompt information may also be an advertisement pushing message about the second article, and can be various information, such as name, model, parameter, price and seller about the second article, which are provided by a commodity supplier to the user, for use as reference information when the user purchases the second article.

Thus it can be seen that the information processing method according to the first embodiment of the present disclosure is applicable to a case that the purchasing behavior of the user with respect to the article has a specific time mode and is irrelevant of other factors.

In a specific application scenario of the first embodiment, the user may get used to buy a bouquet and place it in a house every Sunday, the quantity and variety of flowers purchased every time may be different, and flower seasons of different kinds of flowers may also be different, but those will not affect the habit that the user only purchase the flowers on Sundays. Namely, the time mode of the user's purchasing behavior will not be affected. By using the information processing method according to the first embodiment of the present disclosure, the time mode (also called as temporal rule) of the purchasing behavior of the user can be automatically analyzed and acquired, and a prompt information is generated at proper time to prompt the user that he needs to purchase flowers every Sunday.

In a second embodiment, it is assumed that the time of the future operation behavior of the user with respect to the second article only depends on a historical second operation behavior of the user with respect to the first article, and that the historical second operation behavior may be a usage behavior with respect to the first article, and the future operation behavior is a purchasing behavior with respect to the second article. That is to say, the time of the future purchasing behavior of the user with respect to the second article can only depend on the historical usage behavior of the user with respect to the first article, and is irrelevant of other historical behaviors (for example, purchasing behavior) of the first article.

A specific application scenario of the second embodiment can be that the user sets specific use speed and remaining amount. Specifically, the article can be an article of which the usage behavior is closely related with the use speed. For example, shampoo and body wash used for every shower, daily necessities such as fuel, edible rice and cooking oil and salt, electric energy consumed every moment and the like. In addition, in this embodiment, only the current remaining amount of the article instead of the initial purchasing quantity thereof is mattered. For example, the article can be acquired by non-purchase means such as being presented by others or making by oneself, etc. In addition, it is obvious that the article can also be acquired by way of purchasing.

In this case, multiple historical usage behaviors of the user with respect to the first article can be analyzed to acquire a temporal rule of the multiple historical usage behaviors of the user with respect to the first article as well as the remaining amount of the first article, so the approximate time when the first article will be used up and the approximate time of the future purchasing behavior of the second article associated with the first article can be predicted according to the temporal rule.

Therefore, the step S110 may include: acquiring the multiple historical second operation behavior data of the user with respect to the first article. For example, the second operation behavior can be a usage behavior.

Specifically, in step S110, the multiple usage behavior data (e.g., usage record) of the user with respect to the first article can be determined by various approaches, for example, the usage behavior data can comprise multiple usage time and usage amount each time of the user with respect to the first article.

As mentioned above, as the usage behavior of the first article is only closely related with the use speed (namely, usage amount of each time), and is irrelevant of other behaviors of the first article. In the first embodiment, factors such as the purchasing time and purchasing quantity of the user with respect to the first article need not to be considered.

For example, the multiple usage behavior data (e.g., usage record) of the user with respect to the first article can be acquired by approaches such as the user's manual input, detection of intelligent apparatus and the like.

Specifically, after using the first article every time, the user can manually input parameters such as usage time and usage amount to facilitate later query. Alternatively, the parameters can also be automatically determined by a smart control center (SCC) arranged at user locations (home, office, etc.).

In one example, multiple usage time and usage amount per time of the user with respect to the first article can be automatically detected by a sensor arranged in an accommodation space storing the first article. For example, a number for taking and placing yogurt in a period of time and a remaining amount of yogurt after taking and placing every time of the user in a period of time can be acquired by a weight sensor arranged below a space storing the yogurt in an intelligent refrigerator, and a consumed quantity of the user every time can be counted according to the remaining amount.

In another example, the multiple usage time and usage amount per time of the user with respect to the first article can be automatically detected by a sensor (or a counter) of the first article. For example, power consumed by the user in a period of time and different consumed quantity of the user in different periods can be determined by an intelligent electric meter.

In still another embodiment, residue after use of the first article can be automatically detected by a sensor arranged in a recycling space, and the multiple usage time and usage amount per time of the user with respect to the first article can be automatically detected according to the residue. For example, egg shells thrown by the user can be scanned and recognized by an intelligent trash can to determine the eating times, and eating quantity and the like of the user with respect to eggs in a period of time.

Next, similar to the first embodiment, after step S110 and before step S120, the second article may also be determined according to the first article. As this step has been described in detail in the first embodiment, for the purpose of simplicity, the case in which the first article and the second article are completely identical is taken as an example for description.

Furthermore, after the second article is determined, the step S102 may include: determining a historical second operation behavior mode according to the multiple historical second operation behavior data, wherein the historical second operation behavior mode indicates a temporal rule of multiple historical second operation behaviors of the user with respect to the first article; determining the remaining amount of the first article; and predicting the time of the future operation behavior of the user with respect to the second article according to current time, the remaining amount and the historical second operation behavior mode.

Specifically, after the multiple usage behavior data of the user with respect to the first article are determined, in the step S120, firstly, the historical usage behavior mode of the user with respect to the first article can be determined according to the multiple usage time and usage amount of the user with respect to the first article. For example, the historical usage behavior mode indicates a temporal rule of the multiple historical usage behaviors of the user with respect to the first article.

In a first example, the temporal rule can be that the user uses a certain article according to a certain usage period. For example, the user may get used to drink a bottle of yogurt every day.

In a second example, the temporal rule can be that the user uses certain article at a non-fixed time interval which complies with certain rules (for example, related to various factors, such as seasons, holidays and mood etc.). For example, due to allergies, the user may need to use one disposable mask every day for prevention during severe haze in winter and higher pollen concentration in spring, but does not need to purchase at other time.

Next, the remaining amount of the first article can be determined by least one approaches of: receiving a user input about the remaining amount of the first article; and automatically detecting the remaining amount of the first article.

Specifically, after the user uses the first article each time, the user manually inputs the remaining amount to facilitate later query. Alternatively, the parameters can also be automatically determined by a smart control center (SSC) arranged in user locations (home, office, etc.).

In one example, the remaining amount of the first article can be automatically detected by a sensor arranged in an accommodation space storing the first article. For example, a remaining amount of edible oil after use of the user every time can be acquired by a weight sensor arranged below a space storing the edible oil in an intelligent cabinet.

In another example, the current usage amount in the current usage behavior of the user with respect to the first article can be metered by a sensor, the latest historical remaining amount can be acquired, and the remaining amount of the first article can be calculated according to the latest historical remaining amount and the current usage amount. For example, after the user purchases rice, an initial weight of the rice is manually or automatically input into an electronic apparatus, then the weight of rice currently taken by the user can be determined by an intelligent measuring cup at every usage time, and a current remaining weight of the rice can be acquired according to a remaining weight of last time and the currently taken weight.

In still another example, the residue after use of the first article can be automatically detected by a sensor arranged in a recycling space, the current usage amount in the current usage behavior of the user with respect to the first article can be determined according to the residue, the latest historical remaining amount is acquired, and the remaining amount of the first article is calculated according to the latest historical remaining amount and the current usage amount. For example, after the user purchases disposable masks, an initial amount of the masks is manually or automatically input into an electronic apparatus, and then an intelligent trash can detects an amount of masks discarded by the user, so as to determine a remaining amount of the masks.

Next, current time of the electronic apparatus is acquired, and the time when the user will purchase the second article in the future is determined according to the current time, the remaining amount, and the temporal rule of the multiple historical usage behaviors of the user with respect to the first article.

The case of purchasing the disposable masks is further taken as an example. When it is judged to be winter or spring according to the current time, and the quantity of the masks is judged to be 0, the time when the user will purchase disposable masks next time can be determined to the next day. When it is judged to be summer or autumn according to the current time, the time when the user will purchase the disposable masks next time can be determined to the coming of winter.

After the time of the future operation behavior of the user with respect to the second article is determined, in steps S103 and S140, when it is judged that the current time has gotten to or gotten close to the time when the user will purchase the second article in the future, a purchase prompt information is generated to prompt the user to purchase the second article at the time of the future operation behavior of the user with respect to the second article.

Thus it can be seen that the information processing method according to the second embodiment of the present disclosure is applicable to a case that the usage behavior of the user with respect to the article has a specific time mode and is irrelevant of other factors, and the article has a certain remaining amount.

In one specific application scenario of the second embodiment, the user may get used to drink a bottle of beverage every day, the capacity and brand of each bottle of beverage may be different, and different beverages may be purchased by the user himself or given by a relative, but the habit that the user drinks a bottle of beverage every day will not be affected. By using the information processing method according to the second embodiment of the present disclosure, a time mode (also called as temporal rule) of the usage behavior of the user can be automatically analyzed and acquired, and a remaining amount of the beverage is determined, so a prompt information is generated at proper time to prompt the user of the time when beverage needs to be purchased for the next time and/or recommend to the user advertisements of beverage or other products (such as tea and ice cream) related to the beverage.

In a third embodiment, it is assumed that the time of the future operation behavior of the user with respect to the second article depends on both the historical first operation behavior and the historical second operation behavior of the user with respect to the first article, and that the historical first operation behavior and the future operation behavior can be purchasing behaviors with respect to the first article and the second article, and the historical second operation behavior can be a usage behavior with respect to the first article. That is to say, the time of the future purchasing behavior of the user with respect to the second article can depend on both the historical purchasing behavior and the historical usage behavior of the user with respect to the first article at the same time.

A specific application scenario of the third embodiment can be that the user set a specific use speed and an initial purchasing quantity for an article. Specifically, the article can be an article of which the usage behavior is closely related with the use speed. In addition, in this embodiment, the latest purchasing quantity of the article needs to be considered.

In this case, the latest historical purchasing behavior and multiple historical usage behaviors of the user with respect to the first article may be analyzed to obtain a temporal rule of the multiple historical usage behaviors of the user with respect to the first article, and the initial quantity of the first article is obtained, so that the remaining amount of the first article can be predicted according to the temporal rule, and the approximate time when the first article will be consumed up and the approximate time of the future purchasing behavior of the second article associated with the first article can be accordingly acquired.

Therefore, the step S110 may include: acquiring the latest historical first operation behavior data of the user with respect to the first article according to the current time; and acquiring the multiple historical second operation behavior data of the user with respect to the first article.

As described in the first embodiment, the latest historical purchasing behavior data (e.g., purchasing record) of the user with respect to the first article can be determined in various modes, for example, the purchasing behavior data can comprise the latest historical purchasing time and purchasing quantity of the user with respect to the first article.

In addition, as described in the second embodiment, the multiple usage behavior data (e.g., usage record) of the user with respect to the first article can be acquired in various approaches, for example, the user behavior data can comprise multiple usage time and usage amount per time of the user with respect to the first article.

Next, similar to the first embodiment and the second embodiment, after the step S110 and before the step S120, the second article can also be determined according to the first article. As this step has been described in detail in the first embodiment, for the purpose of simplicity, the case in which the first article and the second article are completely identical is taken as an example.

Furthermore, after the second article is determined, the step S102 may include: determining the latest historical first operation behavior time and the latest historical first behavior quantity of the user with respect to the first article according to the latest historical first operation behavior data; determining a historical second operation behavior mode according the multiple historical second operation behavior data, wherein the historical second operation behavior mode indicates a temporal rule of the multiple historical second operation behaviors of the user with respect to the first article; and predicting the time of the future operation behavior of the user with respect to the second article according to the current time, the latest historical first operation behavior time, the latest historical first operation behavior quantity and the historical second operation behavior mode.

In step S120, the sub-step of predicting the time of the future operation behavior of the user with respect to the second article according to the current time, the latest historical first operation behavior time, the latest historical first operation behavior quantity and the historical second operation behavior mode may include: determining a current second operation behavior mode matching with the current time; and predicting the time of the future operation behavior of the user with respect to the second article according to the latest historical first operation behavior time, the latest historical first operation behavior quantity and the current second operation behavior mode.

Specifically, after a latest historical purchasing behavior data and multiple usage behavior data of the user with respect to the first article are determined, in step S120, a latest historical purchasing behavior time and a latest historical purchasing behavior quantity of the user with respect to the first article can be determined according to the latest historical purchasing behavior data firstly.

Next, as described in the second embodiment, a historical usage behavior mode of the user with respect to the first article can be determined according to the multiple usage time and usage amount of the user with respect to the first article. For example, the historical usage behavior mode indicates a temporal rule of the multiple historical usage behaviors of the user with respect to the first article.

As the historical usage behavior mode may have a longer time span, and may integrally reflects the use frequency and speed of the user with respect to the first article in different periods, in order to precisely reflect the use frequency and speed of the user with respect to the first article at current time, the current usage behavior mode can be further determined from the historical usage behavior mode.

Therefore, the current usage behavior mode can be judged according to the current time and the historical usage behavior mode. For example, it is judged whether it is summer when the user often takes a bath or winter when the user less frequently takes a bath according to the current date of the electronic apparatus, so as to select use frequency and usage amount per time of body wash complying with the current actual condition for subsequent calculating.

Finally, the remaining amount of the first article may be predicted according to the latest historical purchasing behavior time, the latest historical purchasing behavior quantity and the current usage behavior mode, and the time when the user will purchase the second article in the future can be determined according to the remaining amount and the temporal rule of the current usage behavior of the user with respect to the first article.

After the time of the future operation behavior of the user with respect to the second article is determined, in steps S130 and S140, when it is judged that the present time has gotten to or gotten close to the time when the user will purchase the second article in the future, a purchase prompt information is generated to prompt the user to purchase the second article at the predicted time.

Thus it can be seen that the information processing method according to the third embodiment of the present disclosure is applicable to a case that the usage behavior of the user with respect to the article has a specific time mode and the article has a specific initial quantity.

In one specific application scenario of the third embodiment, the user may have purchased a bottle of body wash a month ago, the capacity of the body wash is 1 L, and because it is summer now, the user takes a bath every day, and the body wash is consumed at a very high speed. By using the information processing method according to the third embodiment of the present disclosure, a time mode (also called as temporal rule) of the usage behavior of the user can be automatically analyzed and acquired, and a current remaining amount of the body wash can be determined according to an initial quantity of the body wash, so a prompt information is generated at proper time to prompt the user of the time when the body wash needs to be purchased for the next time and/or recommend to the user advertisements of body wash or other products (such as shampoo and bath sponge) related to the body wash.

In a fourth embodiment, besides the historical operation behavior of the user with respect to the first article, other factors may be further considered, for example, attribute information of the first article and the second article.

The first article and the second article may have different attribute information. For example, the attribute information of the first article and the second article may be service life, price and the like.

Obviously, when the first article has a very long service life, generally speaking, the time of the future operation behavior of the user with respect to the first article will be prolonged. For example, when the user purchases a washing machine, unless an accident occurs, it is almost impossible for the user to purchase another washing machine in a few years, but the user will purchase washing powder, washing machine detergent and the like constantly.

Similarly, when the first article has a high price, the time of the future operation time of the user with respect to the first article will be prolonged. For example, when the user purchases a car, it is hard to expect in how many years the user will purchase another car, but the user will purchase insurance, maintenance service and the like of the car every year.

Therefore, in one embodiment described above or a combination of multiple embodiments, before the time of the future operation behavior of the user with respect to the second article is predicted (namely, the step S120), the information processing method may further include: acquiring first attribute information of the first article.

Further, the step S120 may include: predicting the time of the future operation behavior of the user with respect to the second article according to the user behavior data acquired in step S110 and the first attribute information.

Thus it can be seen that in the information processing method according to the fourth embodiment of the present disclosure, when the future operation time of the second article is estimated, other factors (for example, attribute information of the first article and the second article) can be reasonably considered, so as to generate more accurate predicted time which is complying with actual living conditions.

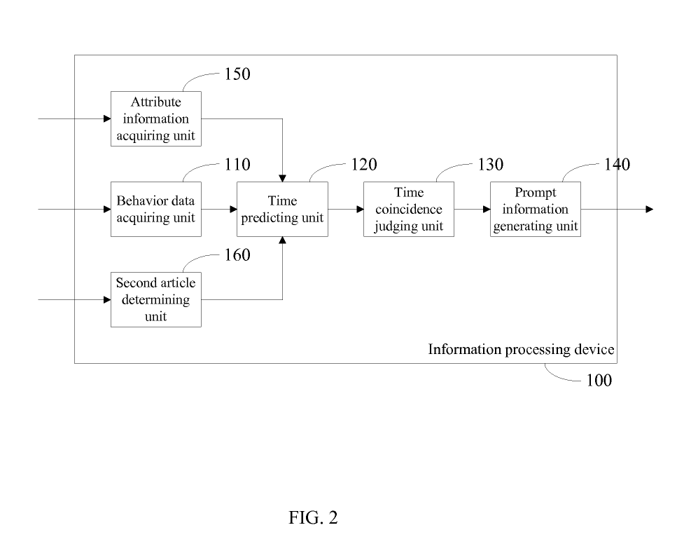

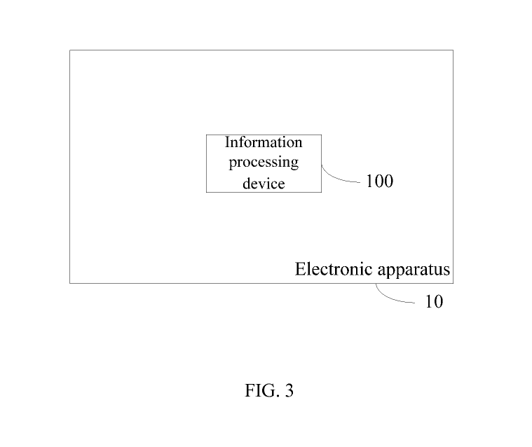

Next, an information processing device and an electronic apparatus according to embodiments of the present disclosure will be described with reference to FIG. 2 and FIG. 3.

FIG. 2 shows an information processing device according to an embodiment of the present disclosure, and FIG. 3 shows an electronic apparatus according to an embodiment of the present disclosure.

The information processing method according to an embodiment of the present disclosure as shown in FIG. 1 can be realized by an information processing device 100 as shown in FIG. 2, and the information processing device 100 can be applied to one or more electronic apparatuses 10 as shown in FIG. 3.

For example, the electronic apparatus 10 can be an electronic apparatus of any kind and comprises but not limited to: a laptop, a tablet computer, a mobile phone, a multimedia player, a personal digital assistant and the like.

As shown in FIG. 3, the electronic apparatus 10 may comprise; an information processing device 100.

The information processing device 100 can be used for acquiring historical operation behavior of a user with respect to a first article, and predicting time of a future operation behavior of the user with respect to a second article according to at least the historical operation behavior of the user with respect to the first article.

In addition, the information processing device 100 can communicate with the electronic apparatus 10 in any manner.

In one example, the information processing device 100 can be integrated into the electronic apparatus 10 as a software module and/or a hardware module. In other words, the electronic apparatus 10 can comprise the information processing device 100. For example, when the electronic apparatus 10 is a mobile phone, the information processing device 100 can be a software module in an operating system of the mobile phone, or can be an application program developed for the mobile phone; certainly, the information processing device 100 can also be one of numerous hardware modules of the mobile phone.

Alternatively, in another example, the information processing device 100 and the electronic apparatus 10 can be separated apparatuses, and the information processing device 100 and the electronic apparatus 10 may be connected through a wired and/or wireless network, and transmit and exchange information according to an agreed data format.

As shown in FIG. 2, the information processing device 100 according to the embodiment of the present disclosure may comprise: a behavior data acquiring unit 110 and an time predicting unit 120.

The behavior data acquiring unit 110 can be used for acquiring user behavior data, and the user behavior data indicates a historical operation behavior of a user with respect to a first article.

The time predicting unit 120 can be used for predicting time of a future operation behavior of the user with respect to a second article according to at least the user behavior data, the second article is an article same as or different from the first article in category, and the future operation behavior is an operation behavior same as or different from the historical operation behavior in category.

In addition, in one embodiment, the information processing device 100 according to the embodiment of the present disclosure may further comprise: a time coincidence judging unit 130 and a prompt information generating unit 140.

The time coincidence judging unit 130 can be used for judging whether current time of the electronic apparatus is consistent with the predicted time after the time predicting unit predicts the time of the future operation behavior of the user with respect to the second article according to at least the user behavior data, and acquiring a first judgment result.

The prompt information generating unit 140 can be used for generating operation prompt information if the first judgment result indicates that the current time is consistent with the predicted time. The operation prompt information is used for prompting the user to execute the future operation behavior with respect to the second article.

In a first embodiment, the behavior data acquiring unit 110 can be used for acquiring the user behavior data by executing an operation of: acquiring multiple historical first operation behavior data of the user with respect to the first article.

In this case, the time predicting unit 120 can predict the time of the future operation behavior of the user with respect to the second article according to at least the user behavior data by operations of: determining a historical first operation behavior mode according to multiple historical first operation behavior data, wherein the historical first operation behavior mode indicates a temporal rule of multiple historical first operation behaviors of the user with respect to the first article; and predicting the time of the future operation behavior of the user with respect to the second article according to current time and the historical first operation behavior mode.

In a second embodiment, the behavior data acquiring unit 110 can be used for acquiring the user behavior data by an operation of acquiring multiple historical second operation behavior data of the user with respect to the first article.

In this case, the time predicting unit 120 can predict the time of the future operation behavior of the user with respect to the second article according to at least the user behavior data by operations of: determining a historical second operation behavior mode according to the multiple historical second operation behavior data, wherein the historical second operation behavior mode indicates a temporal rule of multiple historical second operation behaviors of the user with respect to the first article; determining a remaining amount of the first article; and predicting the time of the future operation behavior of the user with respect to the second article according to current time, the remaining amount and the historical second operation behavior mode.

Specifically, the time predicting unit 120 can determine the remaining amount of the first article in at least one approaches of: receiving a user input about the remaining amount of the first article; and automatically detecting the remaining amount of the first article.

In one embodiment, the time predicting unit 120 can automatically detect the remaining amount of the first article in at least one approaches of: automatically detecting the remaining amount of the first article by a sensor arranged in an accommodation space storing the first article; metering a current usage amount in a current usage behavior of the user with respect to the first article by a sensor, acquiring a latest historical remaining amount, and calculating the remaining amount of the first article according to the latest historical remaining amount and the current usage amount; and automatically detecting residue after use of the first article by a sensor arranged in a recycling space, determining the current usage amount in the current usage behavior of the user with respect to the first article according to the residue, acquiring a latest historical remaining amount and calculating the remaining amount of the first article according to the latest historical remaining amount and the current usage amount.

In a third embodiment, the behavior data acquiring unit 110 can acquire the user behavior data by executing operations of: acquiring latest historical first operation behavior data of the user with respect to the first article according to the current time; and acquiring multiple historical second operation behavior data of the user with respect to the first article.

In this case, the time predicting unit 120 can predict the time of the future operation behavior of the user with respect to the second article according to at least the user behavior data by executing operations of: determining latest historical first operation behavior time and latest historical first operation behavior quantity of the user with respect to the first article according to the latest historical first operation behavior data; determining a historical second operation behavior mode according to the multiple historical second operation behavior data, wherein the historical second operation behavior mode indicates a temporal rule of multiple historical second operation behavior of the user with respect to the first article; and predicting the time of the future operation behavior of the user with respect to the second article according to the current time, the latest historical first operation behavior time, the latest historical first operation behavior quantity and the historical second operation behavior mode.

specifically, the time predicting unit 120 predicts the time of the future operation behavior of the user with respect to the second article according to the current time, the latest historical first operation behavior time, the latest historical first operation behavior quantity and the historical second operation behavior mode by executing operations of: determining a current second operation behavior mode matching with the current time; and predicting the time of the future operation behavior of the user with respect to the second article according to the latest historical first operation behavior time, the latest historical first operation behavior quantity and the current second operation behavior mode.

In one embodiment, the device may further comprise: an attribute information acquiring unit 150.

The attribute information acquiring unit 150 can be used for acquiring first attribute information of the first article.

In this case, the time predicting unit 120 can predict the time of the future operation behavior of the user with respect to the second article according to at least the user behavior data by executing an operation of: predicting the time of the future operation behavior of the user with respect to the second article according to the user behavior data and the first attribute information.

In one embodiment, the device may further comprise: a second article determining unit 160.

Before the time predicting unit predicts the time of the future operation behavior of the user with respect to the second article according to at least the user behavior data, the second article determining unit 160 can determine first category information of the first article, determines at least one candidate article according to the first category information, and determines one or more second articles from the at least one candidate article according to screening conditions.

Specific configurations and operations of respective units in the information processing device 100 and respective devices in the electronic apparatus 10 according to the embodiments of the present disclosure have been described in detail in the information processing method described in FIG. 1, so repetitive description thereof is omitted.

Thus it can be seen that, the information processing device according to the embodiment of the present disclosure can be used for acquiring the historical operation behavior of the user with respect to the first article and predicting the time of the future operation behavior of the user with respect to the second article according to at least the historical operation behavior of the user with respect to the first article, so as to determine the right time for recommending content to the user. Therefore, there is provided an information processing device, by which the information content interested by the user can be timely and accurately recommended to the user.

In addition, although respective embodiments of the present disclosure are described by taking the above respective units as executing entity of respective steps, those skilled in the art should understand that the present disclosure is not limited thereto. The executing entity of the respective steps can be other one or more apparatuses, devices, units or even modules.

For example, the respective steps executed by the behavior data acquiring unit 110, the time predicting unit 120, the time coincidence judging unit 130, the prompt information generating unit 140, the attribute information acquiring unit 150, and the second article determining unit 160 can be uniformly implemented by a central processing unit (CPU) in the electronic apparatus.

Through the description of the above implementation modes, those skilled in the art can clearly see that the present disclosure can be implemented by software plus a necessary hardware platform, and certainly, the present disclosure can also be sheerly implemented by software or hardware. Based on such understanding, all or part of contribution made by the technical solution of the present disclosure to the background art can be embodied in a form of software product, the computer software product can be stored in storage mediums such as an ROM/RAM, a disk, and a CD, and include a plurality of instructions to enable a computer apparatus (which may be a personal computer, a server, a network apparatus or the like) to execute the methods described in respective embodiments or certain parts of the embodiments of the present disclosure.

The respective embodiments of the present disclosure have been described in detail above. However, those skilled in the art should understand that these embodiments can be subjected to various modifications, combinations or sub combinations without departing from the principle and spirit of the present disclosure, and such modifications should fall into the scope of the present disclosure.

1. An information processing method, which is applied to an electronic apparatus, the method comprising:
acquiring behavior data indicating a historical operation behavior related to a first article; and
predicting time of a future operation behavior related to a second article according to at least the behavior data.

2. The method according to claim 1, wherein the acquiring behavior data comprises:
acquiring multiple historical first operation behavior data related to the first article, and
the predicting time of a future operation behavior related to a second article according to at least the behavior data comprises:
determining a historical first operation behavior mode indicating a temporal rule of multiple historical first operation behaviors related to the first article according to the multiple historical first operation behavior data; and
predicting the time of the future operation behavior related to a second article according to current time and the historical first operation behavior mode.

3. The method according to claim 1, wherein the acquiring behavior data comprises:
acquiring multiple historical second operation behavior data related to the first article, and
the predicting time of a future operation behavior related to a second article according to at least the behavior data comprises:
determining a historical second operation behavior mode indicating a temporal rule of multiple historical second operation behaviors related to the first article, according to the multiple historical second operation behavior data;
determining a remaining amount of the first article; and
predicting the time of the future operation behavior related to the second article according to current time, the remaining amount and the historical second operation behavior mode.

4. The method according to claim 3, wherein the determining the remaining amount of the first article is implemented by at least one of:
receiving an input about the remaining amount of the first article; and
automatically detecting the remaining amount of the first article.

5. The method according to claim 4, wherein the automatically detecting the remaining amount of the first article is implemented by at least one of:
automatically detecting the remaining amount of the first article by a sensor arranged in an accommodation space storing the first article;
metering a current usage amount in a current usage behavior of the with respect to the first article by a sensor, acquiring a latest historical remaining amount, and calculating the remaining amount of the first article according to the latest historical remaining amount and the current usage amount; and
automatically detecting residue after use of the first article by a sensor arranged in a recycling space, determining the current usage amount in the current usage behavior of the with respect to the first article according to the residue, acquiring the latest historical remaining amount, and calculating the remaining amount of the first article according to the latest historical remaining amount and the current usage amount.

6. The method according to claim 1, wherein, the acquiring behavior data comprises:
acquiring latest historical first operation behavior data related to the first article according to the current time; and
acquiring multiple historical second operation behavior data related to the first article, and
the predicting time of a future operation behavior related to a second article according to at least the behavior data comprises:
determining latest historical first operation behavior time and latest historical first operation behavior quantity related to the first article according to the latest historical first operation behavior data;
determining a historical second operation behavior mode indicating a temporal rule of multiple historical second operation behaviors related to the first article according to the multiple historical second operation behavior data; and
predicting the time of the future operation behavior related to the second article according to the current time, the latest historical first operation behavior time, the latest historical first operation behavior quantity and the historical second operation behavior mode.

7. The method according to claim 6, wherein, the predicting the time of the future operation behavior related to the second article according to the current time, the latest historical first operation behavior time, the latest historical first operation behavior quantity and the historical second operation behavior mode comprises:
determining a current second operation behavior mode matching with the current time; and
predicting the time of the future operation behavior related to the second article according to the latest historical first operation behavior time, the latest historical first operation behavior quantity and the current second operation behavior mode.

8. The method according to claim 1, wherein, the method further comprises acquiring first attribute information of the first article, and the predicting the time of a future operation behavior related to a second article according to at least the behavior data comprises predicting the time of the future operation behavior related to the second article according to the behavior data and the first attribute information.

9. The method according to claim 1, wherein, before the predicting time of a future operation behavior related to a second article according to at least the behavior data, the method further comprises:
determining a first category information of the first article;
determining at least one candidate article according to the first category information; and
determining one or more second articles from the at least one candidate article according to screening conditions.

10. The method according to claim 1, wherein, after the predicting a time of a future operation behavior related to a second article according to at least the behavior data, the method further comprises:
judging whether current time of the electronic apparatus is consistent with the time of the future operation behavior related to the second article, and acquiring a first judgment result; and
generating an operation prompt information if the first judgment result indicates that the current time is consistent with the time of the future operation behavior related to the second article, wherein the operation prompt information is used for prompting to execute the future operation behavior with respect to the second article.

11. The method according to claim 1, wherein, the second article is an article different from the first article in category, and the future operation behavior is an operation behavior different from the historical operation behavior in category.

12. An information processing device applied to an electronic apparatus, wherein, the device comprises:
a behavior data acquiring unit, for acquiring behavior data indicating a historical operation behavior related to a first article; and
a time predicting unit, for predicting time of a future operation behavior related to a second article according to at least the behavior data.

13. The device according to claim 12, wherein, the behavior data acquiring unit acquires the behavior data by an operation of acquiring multiple historical first operation behavior data related to the first article, and
the time predicting unit predicts the time of the future operation behavior related to the second article according to at least the behavior data by operations of:
determining a historical first operation behavior mode indicating a temporal rule of multiple historical first operation behaviors related to the first article according to the multiple historical first operation behavior data; and
predicting the time of the future operation behavior related to the second article according to current time and the historical first operation behavior mode.

14. The device according to claim 12, wherein, the behavior data acquiring unit acquires the behavior data by executing an operation of acquiring multiple historical second operation behavior data related to the first article, and
the time predicting unit predicts the time of the future operation behavior related to the second article according to at least the behavior data by operations of:
determining a historical second operation behavior mode indicating a temporal rule of multiple historical second operation behaviors related to the first article according to the multiple historical second operation behavior data;
determining a remaining amount of the first article; and
predicting the time of the future operation behavior related to the second article according to current time, the remaining amount and the historical second operation behavior mode.

15. The device according to claim 14, wherein, the time predicting unit determines the remaining amount of the first article by at least one of:
receiving an input about the remaining amount of the first article; and
automatically detecting the remaining amount of the first article.

16. The device according to claim 15, wherein, the time predicting unit automatically detects the remaining amount of the first article by at least one of:
automatically detecting the remaining amount of the first article by a sensor arranged in an accommodation space storing the first article;
metering a current usage amount in a current usage behavior related to the first article by a sensor, acquiring a latest historical remaining amount, and calculating the remaining amount of the first article according to the latest historical remaining amount and the current usage amount; and
automatically detecting residue after use of the first article by a sensor arranged in a recycling space, determining the current usage amount in the current usage behavior related to the first article according to the residue, acquiring a latest historical remaining amount, and calculating the remaining amount of the first article according to the latest historical remaining amount and the current usage amount.

17. The device according to claim 12, wherein, the behavior data acquiring unit acquires the behavior data by:
acquiring latest historical first operation behavior data related to the first article according to the current time; and
acquiring multiple historical second operation behavior data related to the first article, and
the time predicting unit predicts the time of the future operation behavior related to the second article according to at least the behavior data by operations of:
determining latest historical first operation behavior time and latest historical first operation behavior quantity related to the first article according to the latest historical first operation behavior data;
determining a historical second operation behavior mode indicating a temporal rule of multiple historical second operation behaviors related to the first article according to the multiple historical second operation behavior data; and
predicting the time of the future operation behavior related to the second article according to the current time, the latest historical first operation behavior time, the latest historical first operation behavior quantity and the historical second operation behavior mode.

18. The device according to claim 17, wherein, the time predicting unit predicts the time of the future operation behavior related to the second article according to the current time, the latest historical first operation behavior time, the latest historical first operation behavior quantity and the historical second operation behavior mode by operations of:
determining a current second operation behavior mode matching with the current time; and
predicting the time of the future operation behavior related to the second article according to the latest historical first operation behavior time, the latest historical first operation behavior quantity and the current second operation behavior mode.

19. The device according to claim 12, wherein, the device further comprises:
an attribute information acquiring unit, for acquiring first attribute information of the first article, and
the time predicting unit predicts the time of the future operation behavior related to the second article according to at least the behavior data by an operation of predicting the time of the future operation behavior related to the second article according to the behavior data and the first attribute information.

20. The device according to claim 12, wherein, the device further comprises a second article determining unit, for determining first category information of the first article before the time predicting unit predicts the time of the future operation behavior related to the second article according to at least the behavior data, determining at least one candidate article according to the first category information, and determining one or more second articles from the at least one candidate articles according to screening conditions.

21. The device according to claim 12, wherein, the device further comprises:
a time coincidence judging unit, for judging whether current time of the electronic apparatus is consistent with the time of the future operation behavior related to the second article after the time predicting unit predicts the time of the future operation behavior related to the second article according to at least the behavior data, and acquiring a first judgment result; and
a prompt information generating unit, for generating an operation prompt information if the first judgment result indicates that the current time is consistent with the time of the future operation behavior related to the second article, wherein the operation prompt information is used for prompting to execute the future operation behavior with respect to the second article.

22. The device according to claim 12, wherein the second article is an article different from the first article in category, and the future operation behavior is an operation behavior different from the historical operation behavior in category.
